(19) United States
(12) Patent Application Publication
(10) Pub. No.: US 2014/0288855 A1
(43) Pub. Date: Sep. 25, 2014

(54) Temporary Uprating of Wind Turbines to Maximize Power Output

(71) Applicant: United Technologies Corporation, Hartford, CT (US)

(72) Inventor: Ameet Deshpande, Schenectady, NY (US)

(21) Appl. No.: 13/847,887

(22) Filed: Mar. 20, 2013

(51) Int. Cl. F03D 11/00

(52) U.S. Cl. CPC F03D 11/0091
USPC 702/34

(57) ABSTRACT

A control strategy for uprating the rated power of a wind turbine at times during the design life includes measuring an operating parameter for a component of the wind turbine as the wind turbine operates at a design rated speed and a design rated torque, and calculating an actual accumulated damage amount for the component based on a measured value of the operating parameter. The strategy may further include calculating an updated rated speed and an updated rated torque for the wind turbine based on the actual accumulated damage amount, a wind speed, a wind turbulence and a remaining design life amount of the wind turbine, and causing the wind turbine to operate at the updated rated speed and the updated rated torque.

### FIELD OF THE DISCLOSURE

The present disclosure generally relates to wind turbines and, more particularly, relates to control strategies for uprating the rated power of wind turbines at times during their design lives to maximize the power generated over the useful lives of the wind turbines.

### BACKGROUND OF THE DISCLOSURE

A utility-scale wind turbine typically includes a set of two or three large rotor blades mounted to a hub. The rotor blades and the hub together are referred to as the rotor. The rotor blades aerodynamically interact with the wind and create lift or drag, which is then translated into a driving torque by the rotor. The rotor is attached to and drives a main shaft, which in turn is operatively connected via a drive train to a generator or a set of generators that produce electric power. The main shaft, the drive train and the generator(s) are all situated within a nacelle, which rests on a yaw system that continuously pivots along a vertical axis to keep the rotor blades facing in the direction of the prevailing wind current to generate maximum torque.

A typical or ideal power curve 1 for a wind turbine is shown in FIG. 1. The power curve 1 is a graph of the wind speed w versus the power P output by the wind turbine. At a cut-in wind speed 2, the rotor and, correspondingly, the main shaft begin to turn and drive the generators to produce electric power. As the wind speed w increases within a region I, the power P output by the wind turbine increases until the power curve 1 enters a region II where the rated wind speed 3 cause the rated power P^{r} to be output by the wind turbine. As can be seen, when the rotor reaches its rated speed 3, any further power output increase is prevented as the wind speed w increases into a region III. In region III, the output power P is limited or controlled, typically by pitching the rotor blades out of the wind toward a feathered position in which the torque exerted by the blades about the hub is maintained to continue to produce at approximately the rated power P^{r}. If the wind speed w continues to increases beyond a cut-out wind speed 5, the blades may be rotated to the full feathered position into the direction of the wind to substantially prevent rotation of the rotor and prevent damage to the components of the wind turbine caused by high wind conditions.

The wind turbine is designed to produce power at its rated power output under a certain set of standard environmental conditions, including assumed wind speed, turbulence, temperature, density, and the like. At rated power and under these standard environmental conditions, the stresses and strains on structures and components, the temperatures of the gearbox oil and the generators, the current and voltages in the electrical system hardware, and the like, will all remain within their respective extreme load design parameters. In addition to designing the machine to withstand these extreme loads, the machine must be designed for adequate fatigue life that matches or exceeds the intended design life. Additional assumptions are made about how the wind conditions change over time, i.e. what portion of the time will the wind be in region I in the power curve 1 of FIG. 1, and what portion of the time in region III. Given this set of ideal assumptions, the fatigue life of each component and structure is calculated to ensure it meets or exceeds the intended design life. Thus a wind turbine is designed to live within an envelope of extreme instantaneous loads, and designed to have a sufficient fatigue life to meet the intended design life.

Ideally, the wind turbine will operate at the rated power P^{r} for the duration of its design life and the components will reach their fatigue damage limits at the end of the design life so that the owner will receive a maximum return on the investment in the wind turbine. However, the actual environmental conditions during operation of the wind turbine at the rated power P^{r} output may be different than the assumed ideal conditions. Over the design life of the wind turbine, the wind conditions may be milder than those expected when the wind turbine was designed. Consequently, the calculated rate of fatigue damage found during the design stage assuming idealized wind conditions might turn out to be greater than the actual rate of accumulation of fatigue damage. In this case, if it continues, the actual fatigue life of the machine, the actual amount of operational time before the machine wears out, might be longer than the intended design life.

In some previously known wind turbines, control functionality has been provided to allow the wind turbines to operate above their rated power P^{r} but within an envelope of extreme loads that can cause damage to the components of the wind turbine. In such control functionality, current values of operating parameters for the wind turbines, such as electrical, mechanical, thermal and meteorological operating parameters, are evaluated to determine whether to uprate the rated power P^{r} to a value that is greater than the designed rated power P^{r} and within the envelope of extreme loads. The control functionality does not, however, incorporate accumulated fatigue damage into the determination of whether to uprate the wind turbine. In view of the limitations existing in previously known wind turbine control strategies, a need exists for power uprating systems capable of accounting for accumulated fatigue damage and the remaining design life of components of a wind turbine in addition to the wind speed w and turbulence a, in the decision to uprate the power rating of the wind turbine.

### SUMMARY OF THE DISCLOSURE

In accordance with one aspect of the present disclosure, a method for rerating a wind turbine is disclosed. The method may include determining a wind speed, a wind turbulence, an actual accumulated fatigue damage amount for at least one component of the wind turbine, and a remaining design life amount for the wind turbine, and calculating, by a computer processer, an updated rated speed and an updated rated torque based on the wind speed, the wind turbulence, the actual accumulated damage amount and the remaining design life amount.

In accordance with another aspect of the present disclosure, a method for determining an updated rated power for a wind turbine is disclosed. The method may include measuring at least one operating parameter for at least one component of the wind turbine as the wind turbine at a design rated speed and a design rated torque, and calculating, by a computer processor, an actual accumulated damage amount for the component based on a measured value of the operating parameter. The method may further include calculating an updated rated speed and an updated rated torque for the wind turbine based on the actual accumulated damage amount, a wind speed, a wind turbulence and a remaining design life amount of the wind turbine, and causing the wind turbine to operate at the updated rated speed and the updated rated torque.

Additional aspects are defined by the claims of this patent.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is an exemplary power curve for a wind turbine;

FIG. 2 is an elevational view of an exemplary wind turbine that may implement the temporary uprating system in accordance with at least some embodiments of the present disclosure;

FIG. 3 is a rear schematic illustration of the exemplary wind turbine of FIG. 2;

FIG. 4 is a schematic illustration of an exemplary control unit that may be implemented in the exemplary wind turbines of FIG. 2;

FIG. 5 is a schematic illustration of a wind turbine farm integrating a plurality of the exemplary wind turbines of FIG. 2; and

FIG. 6 is a schematic illustration of various components of a system for temporarily uprating the wind turbine of FIG. 2 in accordance with an embodiment.

While the following detailed description has been given and will be provided with respect to certain specific embodiments, it is to be understood that the scope of the disclosure should not be limited to such embodiments, but that the same are provided simply for purposes of illustration.

### DETAILED DESCRIPTION OF THE DISCLOSURE

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning.

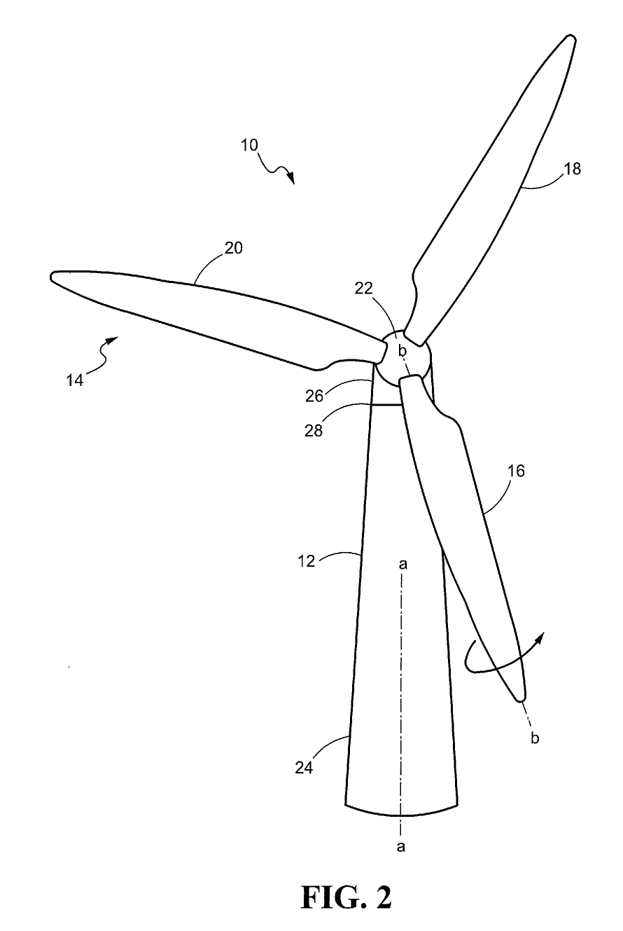

Referring initially to FIG. 2, an exemplary wind turbine 10 is schematically shown in accordance with at least one embodiment of the present disclosure. While all components of the wind turbine are not shown or described herein, the wind turbine 10 may include a vertically standing tower 12 having a vertical axis “a-a”, and supporting a rotor 14. The rotor 14 is defined by a collective plurality of equally spaced rotor blades 16, 18, 20, each connected to and radially extending from a hub 22 as shown. The rotor blades 16, 18, 20 may be rotated by wind energy such that the rotor 14 may transfer such energy via a main shaft (not shown) to one or more generators (not shown). Those skilled in the art will appreciate that such wind-power driven generators may produce commercial electric power for transmission to an electric grid (not shown). Those skilled in the art will appreciate that a plurality of such wind turbines may be effectively employed on a so-called wind turbine farm to generate a significant amount of electric power. Although the disclosed embodiments focus on wind only, this disclosure is pertinent to fluids generally, including other gases and even liquids such as water, that may be used to drive similar turbine structures.

In the embodiments described herein, each of the rotor blades 16, 18, 20 is individually adjustable, i.e. it can be pitched about its radial axis “b-b” (shown only with respect to rotor blade 16 for simplicity) independently of the pitch angle of any other blade. Generally, the rotor blades 16, 18, 20 can be individually pitched toward a feathered position in which the rotor blade 16, 18, 20 produces little or no torque about the hub 22, or toward a power position in which the rotor blade 16, 18, 20 produces a maximum amount of torque about the hub 22.

The hub 22 is attached through a main shaft (not shown) to a nacelle 26 as shown. The nacelle 26 is adapted to revolve about the vertical axis a-a at the top of the vertically standing tower 12 at the interface 28 of the vertically standing tower 12 and nacelle 26. Such turntable like nacelle movement is within a generally horizontal plane (not shown) that passes through the interface 28, and is managed by a yaw control system (not shown). The rotatable nacelle 26 may be adapted to freely turn, so as to be able to position the rotor 14 directly perpendicularly to any prevailing winds, and to thereby optimize power generation under conditions of shifting winds.

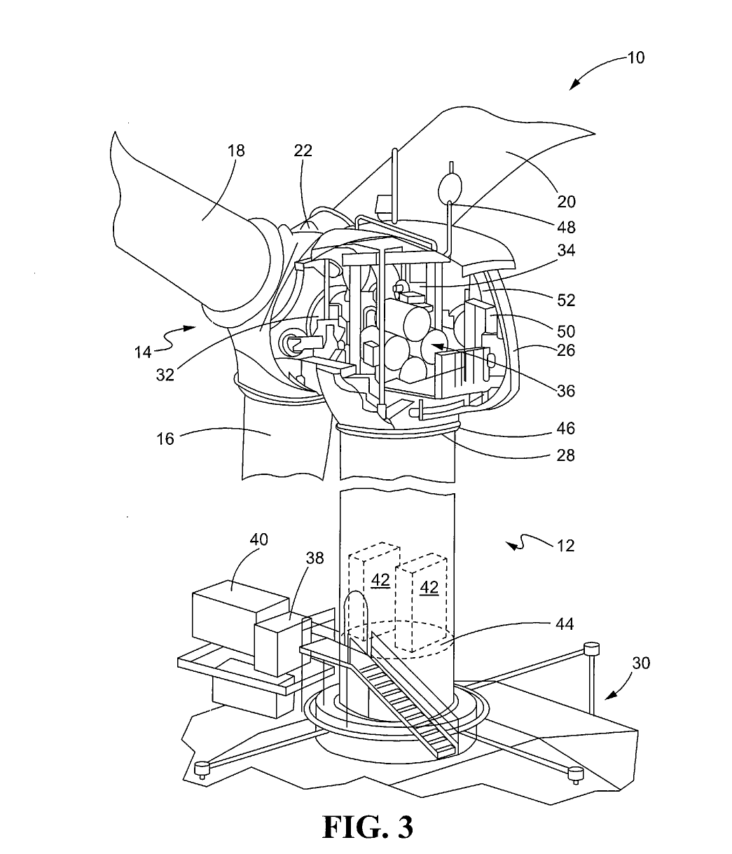

Turning to FIG. 3, the exemplary wind turbine 10 is illustrated with the components shown in greater detail. The vertically standing tower 12 is shown with an intermediate section removed for inclusion of a base 30 of the wind turbine 10 in the drawing figure, and the rotor 14 is shown from behind for better illustration of the nacelle 26 and associated components. The rotor blades 16, 18, 20 may rotate with wind energy and the rotor 14 may transfer that energy to a main shaft 32 situated within the nacelle 26. The nacelle 26 may optionally include a drive train 34, which may connect the main shaft 32 on one end to one or more generators 36 on the other end. Alternatively, the one or more generators 36 may be connected directly to the main shaft 32 in a direct drive configuration. The one or more generators 36 may generate power, which may be transmitted through the vertically standing tower 12 to a power distribution panel (PDP) 38 and a pad mount transformer (PMT) 40 for transmission to a grid (not shown). The PDP 38 and the PMT 40 may also provide electrical power from the grid to the wind turbine 10 for powering several components thereof. The base 30 may further include a pair of generator control units (GCUs) 42 and a down tower junction box (DJB) 44 to further assist in routing and distributing power between the wind turbine 10 and the grid. The generator control unit 42 may alternately be housed within the nacelle 26. Several other components, such as ladders, access doors and the like, that may be present at the base 30 of the wind turbine 10 are contemplated and considered within the scope of the present disclosure.

The nacelle 26 may be positioned on a yaw system 46, which may pivot about the vertical axis a-a to orient the wind turbine 10 in the direction of the wind current. In addition to the aforementioned components, the wind turbine 10 may also include a pitch control system (not visible) having a pitch control unit (PCU) situated within the hub 22 for controlling the pitch (e.g., angle of the rotor blades 16, 18, 20 with respect to the wind direction) of the rotor blades 16, 18, 20 and an anemometer 48 for measuring the speed, direction and turbulence of the wind relative to the wind turbine 10, with the turbulence representing the standard deviation of the wind speed (zero turbulence=constant wind speed). A turbine control unit (TCU) 50 and control system 52 may be situated within the nacelle 26 for controlling the various components of the wind turbine 10 and for performing functions of the uprating control system.

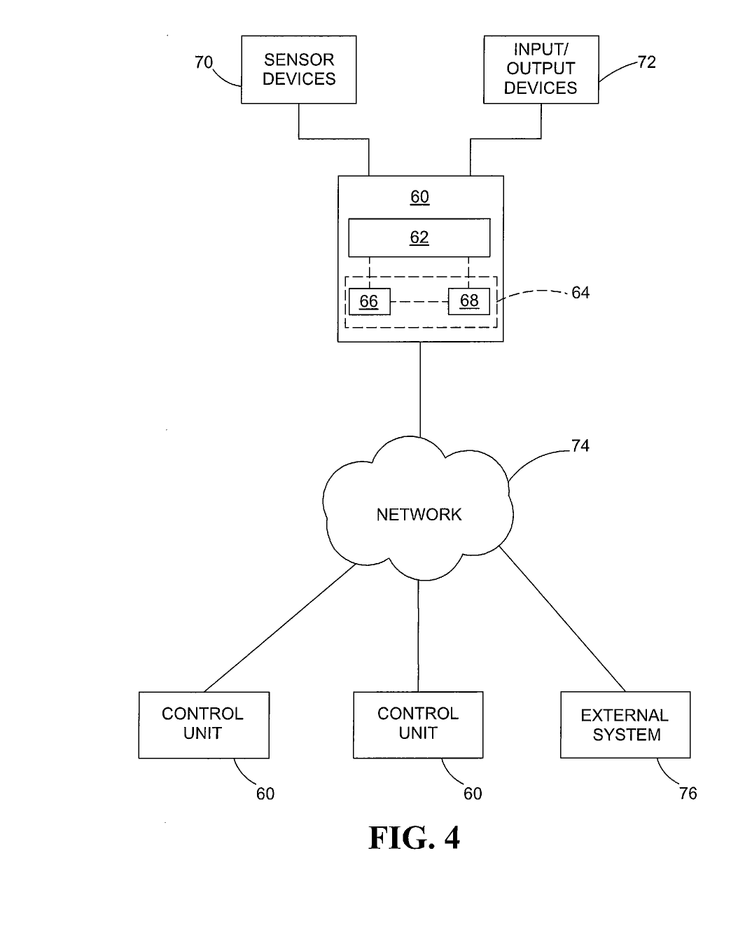

The generator control unit 42 and the turbine control unit 50 may be any appropriate control unit capable of performing control functions to control the various components of the wind turbine 10. FIG. 4 illustrates one example of a control unit 60 that may be implemented in the wind turbine 10. The control unit 60 may include a microprocessor 62 for executing a specified program, which controls and monitors various functions associated with the wind turbine 10. The microprocessor 62 includes a memory 64, such as ROM (read only memory) 66, for storing a program or programs, and a RAM (random access memory) 68 which serves as a working memory area for use in executing the program(s) stored in the memory 64. Although the microprocessor 62 is shown, it is also possible and contemplated to use other electronic components such as a microcontroller, an ASIC (application specific integrated circuit) chip, or any other integrated circuit device. The control unit 60 electrically connects to sensor devices 70, such as the anemometer 48, and to input/output devices 72 of the wind turbine 10 that transmit information and control signals to, and receive information and control signals from, the control unit 60. The control unit 60 also electrically connects to a communication network 74 that in turn connects the control unit 60 to other control units 60 (i.e., TCU 50 connected to GCU 42) and external systems 76 for exchanging information.

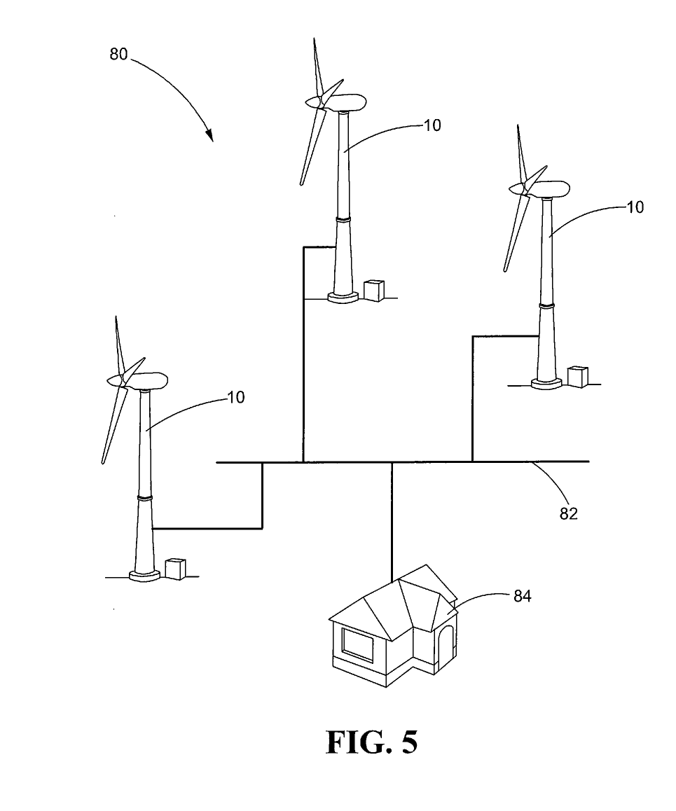

It is common for an owner/operator to have groups of the wind turbines 10 installed and operating in the same geographic area that is conducive to capturing the energy provided by the wind, such as in an area of open farmland or in a body of water. These areas provide flat open spaces free of obstructions that can block the wind. FIG. 5 provides a schematic illustration of a wind turbine farm 80 formed by a plurality of wind turbines 10. As discussed above, each wind turbine 10 may include generator control units 42 and control systems 52 in the turbine control unit 50 that may monitor the operations of the wind turbines 10 and implement control strategies for the safe operation of the wind turbines 10 according to their designs. The generator control units 42 and control systems 52 of the various wind turbines 10 may be connected via a network 82 to a central control center 84 that may be located at the wind turbine farm 80 or at a remote location. The central control center 84 may include one or more control units 60 as described above or other similar control unit. The logic for uprating the wind turbines 10 in accordance with the present disclosure may be performed solely at each wind turbine 10 by the control system 52 of the turbine control unit 50, by the generator control unit 42, or by a distributing the logic between the TCU 50 and the GCU 42, may be centralized at the central control center 84 to implement a cohesive overall uprating strategy for the wind turbine farm 80, or may have components of the uprating system distributed between the TCUs 50 and the GCUs 42 of the wind turbines 10 and the central control center 84 to ensure efficient execution of the various functions of the uprating strategy. Alternatives for distribution of the functions of the uprating strategy will be apparent to those skilled in the art and are contemplated by the inventor.

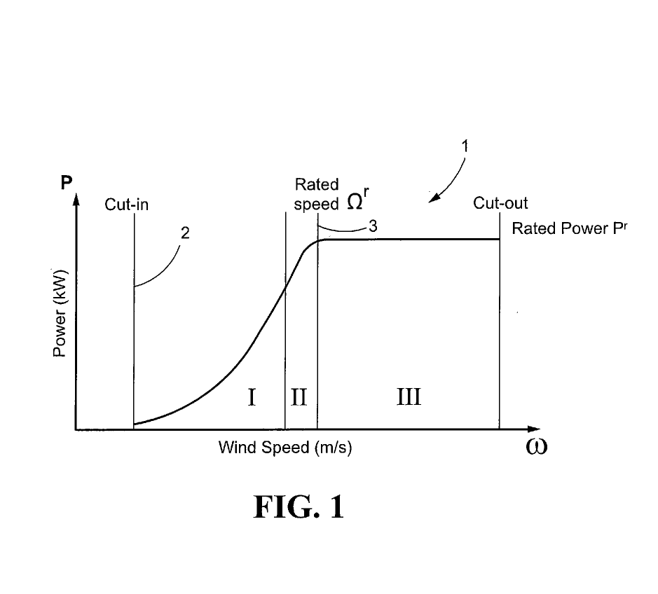

As discussed above, wind turbines 10 typically operate according to a power curve similar to that shown in FIG. 1. The wind turbines 10 are designed to produce electricity at the rated power P^{r} over the design life of the wind turbine 10. The rated power P^{r} will have corresponding rated torque T^{r} and rated speed Ω^{r} setpoints that govern the operation of the wind turbine 10.

Per the design, the wind turbine 10 would operate at the rated speed Ω^{r} and the rated torque T^{r} to produce the rated power P^{r} for the duration of the design life, at which time components of the wind turbine 10 would accumulate the designed amount of fatigue damage and be ready for replacement, or the wind turbine 10 would be ready for retirement. In reality, however, the wind speed w varies such that the wind turbines 10 operate in varying amounts in each of the regions I, II and III of the power curve 1 of FIG. 1. The wind turbine 10 operates at or close to the rated power P^{r} in regions II and III, but operate below the rated power P^{r} in region I. Correspondingly, the components of the wind turbine 10 accumulate fatigue damage at a slower rate than anticipated in the design such that the components may have useful life remaining at the end of the design life of the wind turbine 10. The remaining useful life represents a wasted investment for the owner/operator of the wind turbine 10. This also represents lower power production and, correspondingly, lower revenue than could have been produced at higher wind speeds w.

The system in accordance with the present disclosure allows the wind turbine 10 to operate above the design rated power P^{r} when appropriate to generate additional electricity and to accumulate fatigue damage in the components at higher rates such that the owner/operator can get close to the full value out of their investment. At the same time, the wind turbine 10 may be restricted to operating below the design rated power P^{r} based on factors such as excess wind turbulence a, excess fatigue damage or other damage to components, optimization of economic output of the wind turbine 10 and the like. During operation of the wind turbine 10, the control system of the wind turbine 10, or group of wind turbines 10, may record data that may allow the system to calculate the accumulated fatigue damage on various components of the wind turbine 10, and in particular those most likely to fail due to accumulated fatigue damage over time. The data may include loads applied to the rotor blades 16, 18, 20, the one or more generators 36 and the vertically standing tower 12, the numbers of rotational cycles of the rotor 14, the main shaft 32, the one or more generators 36 and other rotating components, temperature load data for electrical elements, and other condition monitoring data relevant to the operation of the wind turbine 10. Data may also include measurement of the wind and other climatic elements. The control system may input the data into transfer functions or other mathematical tools to determine the fatigue damage accrued by the components from the time the wind turbine 10 was put into service to the present.

With the remaining design life of the wind turbine 10 known, and the accumulated fatigue damage calculated, the control system may determine whether to uprate the speed Ω^{r} and torque T^{r} setpoints of the wind turbine 10 to recapture fatigue damage that was not accumulated during low wind speed periods or to downrate to prolong the useful life of the wind turbine 10. In addition to the remaining design life and the accumulated fatigue damage, the control system may use the wind speed w and the wind turbulence σ in the uprating decision. The remaining design life, accrued fatigue damage, average wind speed w and the wind turbulence σ may be input into a pre-calculated look-up table or transfer function to determine whether uprating the rated power P^{r} of the wind turbine 10 is appropriate and, if so, determine the uprated speed Ω^{r} and torque Tr setpoints at which to safely operate the wind turbine 10 to generate more electricity and to accrue fatigue damage at a faster rate. The uprating magnitude may still be constrained by operational limits on the components of the system, and thus the uprating may be more limited than an ideal amount to fully recapture the foregone fatigue damage. Moreover, the control system may monitor the components during the uprating period to ensure that the operational limits are not exceeded and to potentially override the uprating decision if necessary. However, once the uprated power P^{r} is determined, the wind turbine 10 operates at the uprated levels and the control system continues to receive data from the wind turbine 10 for accumulation of fatigue damage for the components and for future uprating and/or downrating decisions.

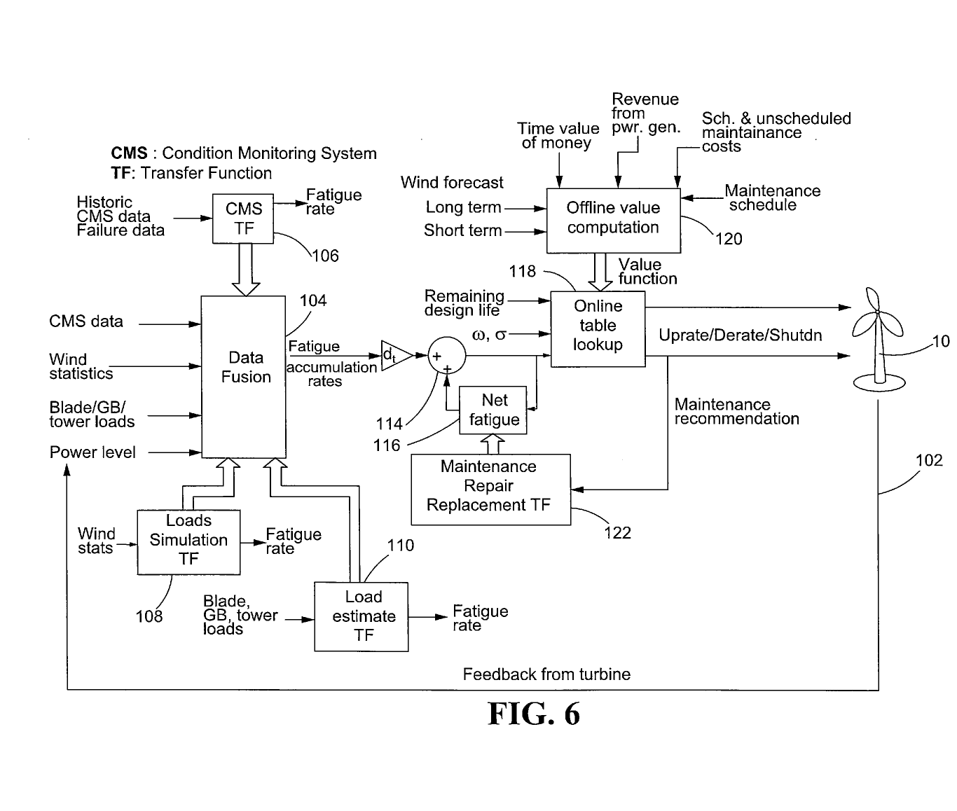

FIG. 6 provides a schematic illustration of a system 100 for making uprating decisions for the wind turbine 10. The various components and functions of the system 100 described herein may be implemented at the wind turbine 10 in the turbine control unit 50 and/or the generator control unit 42, at a control unit 60 of the central control center 74, or distributed in an appropriate manner between the components of the wind turbine 10 and wind turbine farm 80. Moreover, the various components may be implemented as software programmed into the control units 60, as hardware in the form of electronics systems, circuits and the like, or as combinations thereof as necessary to implement the functions of the system 100 in a particular installation environment.

During normal operations as the wind turbine 10 rotates to generate electricity under the influence of the wind, sensors at and within the wind turbine 10 measure various data pertaining to the operation of the wind turbine 10 and the wind causing the wind turbine 10 to move. Many different types of information relevant to the uprating decision are collected. For example, the wind turbine 10 may be outfitted with strain gauges or other types of devices for sensing loads applied to the rotor blades 16, 18, 20, the vertically standing tower 12 and the one or more generators 36 due to the force of the wind, the rotation of the rotor and the torque applied on the main shaft 32. The anemometer 48 may measure the wind speed w and the wind turbulence σ and the control system 52 may generate statistics for the wind conditions over a period of time. Temperature sensors such as thermocouples, pressure sensors, and other types of sensors of a condition monitoring system may measure additional information relevant to determining the fatigue damage or other damage being accumulated by the various components of the wind turbine 10 or monitoring various operation limits of the components. For each type of sensor, the sampling rate will vary based on the type of data being collected and the rate at which values of the sensed data will change.

The collected data will be used by the system 100 in making the uprating decision. The data may be transmitted over a feedback loop 102 to a data fusion or fatigue damage accumulation rate routine 104. The fatigue damage accumulation rate routine 104 may be configured to use the feedback data from the wind turbine 10 to calculate fatigue damage accumulation rates for the components of the wind turbine 10 and in particular those most likely to fail. The components may accumulate fatigue damage at different rates, and different factors may contribute to the accumulation of fatigue damage. The fatigue damage accumulation rate routine 104 may be configured to account for the various fatigue damage factors to arrive at the fatigue damage accumulation rates.

One factor in the fatigue damage rate for the components may be the historic fatigue damage and failure rates that cannot be measured directly due to the nature of the components, such as roller bearings. Historical condition monitoring system data for wind turbines 10 may be available from older wind turbines 10 that have been replaced or retired, along with failure data for the components. The fatigue damage rates for the components are also known from the historical data. This data allows a condition monitoring system (CMS) transfer function 106 to be determined. Current CMS data from the wind turbine 10 may be input to the CMS transfer function 106 to yield a CMS fatigue damage rate for the components in the fatigue damage accumulation rate routine 104.

In addition to the general weather conditions, the actual wind conditions contribute to the fatigue damage rate in the wind turbine 10. During the design of the wind turbine 10, the design engineer can simulate the loads created in the components by various combinations of wind speed w and wind turbulence a, and the corresponding fatigue damage rate components attributable to the wind. A load simulation transfer function 108 may be determined based on the simulations and used within the fatigue damage accumulation rate routine 104 to provide an additional fatigue damage rate component based on the wind statistics gathered at the wind turbine 10.

An additional fatigue damage rate component may be determined from the actual loads recorded by the sensors on the components of the wind turbine 10 that allow direct measurement of loads, such as the vertically standing tower 12, rotor blades 16, 18, 20 and the one or more generators 36. The actual loads experienced by the components may be different from the anticipated loads based on the windy conditions for many reasons, such as greater or less lubrication than expected that can affect the amount of friction in the system and torque and shear loads on the components. For this reason, a load estimate transfer function 110 may be added to the fatigue damage accumulation rate routine 104 to adjust the calculated fatigue damage accumulation rates up or down depending on the actual sensed loads.

Those skilled in the art will understand that the transfer functions 106, 108, 110 are merely exemplary and more or fewer fatigue damage rate components may be taken into account based on the availability of data and the ability to estimate fatigue damage rates from the data that is available. Moreover, transfer functions are used herein is one example of mathematical models for outputting fatigue damage rates based on input data. Other methods for determining fatigue damage rate components may be implemented, including alternative mathematical and statistical tools, pre-calculated look-up tables, and the like. The use of such alternative mechanisms is contemplated by the inventor is having used in systems 100 in accordance with present disclosure.

The feedback data from the wind turbine 10 transmitted on the feedback loop 102 along with additional data are input to the fatigue damage accumulation rate routine 104 to determine the overall fatigue damage accumulation rates for the relevant components of the wind turbine 10. CMS data and failure data are input into the CMS transfer function 106, wind statistics are input into the load simulation transfer function 108, and load data is input into the load estimate transfer function 110. Power level information may also be input into the fatigue damage accumulation rate routine 104 and used to determine the fatigue damage rates, and calculated fatigue damage accumulation rates may be output from the fatigue damage accumulation rate routine 104 to a differentiator 112. The differentiator 112 may receive the fatigue damage accumulation rates from the fatigue damage accumulation rate routine 104 and determine fatigue damage amounts accumulated by the components over a time period dₜ. The time period dₜ may be the amount of time that has elapsed since the last calculation of the fatigue damage amounts or some other amount of time that is relevant to determining the amount of additional fatigue damage that has been incurred by the components of the wind turbine 10 since the net fatigue damage was last calculated.

The incremental fatigue damage amounts calculated and output by the differentiator 112 may then be input to an adder 114. The adder 114 may also receive input of net fatigue damage or other damage for the components of the wind turbine 10 from a net fatigue damage or accumulated fatigue damage storage 116. The net fatigue damage may represent the cumulative damage incurred by the components from the time the wind turbine 10 was put into service up through the last calculation of the incremental fatigue damage amounts by the fatigue damage accumulation rate routine 104 and differentiator 112. The new incremental fatigue damage amounts may be added to the net fatigue damage amounts to yield new accumulated fatigue damage amounts for the components. At the output of the adder 114, the new accumulated fatigue damage amounts may be input back into the accumulated fatigue damage storage 116 to update the net fatigue damage amounts for the components for use in subsequent net fatigue damage calculations.

Once the new accumulated fatigue damage amounts are determined, the determination may be made as to uprating or downrating the rated power P^{r} of the wind turbine 10. In one embodiment, the determination may be made via an online lookup table 118. In a basic form, the online lookup table 118 receives the new accumulated fatigue damage amounts D from the adder 114, a value representing the remaining design life s of the wind turbine 10 (i.e. if the wind turbine 10 was designed to operate for 20 years and has been in service for five years, the remaining design life is 15 years), values for the current wind speed w and wind turbulence σ, and outputs values for the rated torque T^{r} and the rated speed Ω^{r} that may be greater than, less than or the same as the current values of the torque T^{r} and speed Ω^{r}. The values for the wind speed w and wind turbulence σ may be input separately or may be transmitted from the fatigue damage accumulation rate routine 104 with the fatigue damage accumulation rates that are input to the differentiator 112.

The data provided in the online lookup table 118 may be computed off-line of the turbine control unit 50, possibly at the central control center 74, and then uploaded to the turbine control unit 50 for performance of table lookups when making the uprating decision. Computing the data in the online lookup table 118 may be mathematically and computationally intensive, so the computations may be performed off-line rather than during each control cycle of the wind turbine 10 and utilizing resources that are required for controlling the operation of the wind turbine 10. The online lookup table 118 may also be in the form of a mathematical formula that receives the inputs and responds with values for the rated torque T^{r} and the rated speed Ω^{r}.

The lookup table or mathematical formula may be calculated using the dynamic programming optimization technique, or other appropriate technique for generating the data where formulas are used in the uprating decision. The dynamic programming technique is discussed in greater detail below. Whether the lookup table or mathematical formula is used in the online lookup table 118, the particular tool will be configured such that certain extreme loads will always be respected, and the output of the speed Ω^{r} and the torque T^{r} of the wind turbine 10 will be such that the resulting operation will not exceed the extreme load limits. For example, for a 2.5 MW wind turbine 10, an uprated power P^{r} of 2.7 MW may allow the wind turbine 10 to recapture electricity and component fatigue damage, but may cause the one or more generators 36 to overheat. Consequently, the online lookup table 118 will be configured to output a maximum uprated power P^{r} that is less than 2.7 MW.

Despite the extreme load limitations, the method may be configured to handle extreme loads in a hybrid manner. Some extreme loads, such as stresses on a structure and other predictable loads, may be accounted for in programming the lookup table or formula. Other extreme loads may be handled by real-time monitoring that may override the uprated speed Ω^{r} and torque T^{r} is the real-time monitoring detects that the excursion into a higher rated power output may exceed a load limit. Real-time monitoring may be especially helpful for respecting limits on certain temperatures, currents, voltages and the like in the electrical system. The control system 52 of the turbine control unit 50 may monitor the critical parameters. If the values of the measured parameters exceed predefined threshold values, or of the values exceed a threshold rate of increase, or a combination of both, the control system 52 may reduce or cancel the uprated speed Ω^{r} and torque T^{r} setpoints.

In the illustrated embodiment of the system 100, various types of information may be factored into the calculation of the online lookup table or formula 118 and the decision on uprating or downrating the wind turbine 10. At an off-line value computation routine 120 that may be executed remotely from the wind turbine 10, climatic, operational and economic factors may be evaluated to arrive at a value function V that reflects the costs and benefits of changing the rated power P^{r} of the wind turbine 10 at different points in time. Short-term and long-term wind forecasts may be used to identify optimal and suboptimal time periods for operating the wind turbine 10 above or below its rated power P^{r}. Where high winds and high turbulence are forecast for the immediate future, it may be preferable to defer to uprating the wind turbine 10 until a later time where high winds with low turbulence are expected.

The maintenance schedule and the relative costs for scheduled and unscheduled maintenance may be taken into account. In general, the cost of replacing parts is less during scheduled maintenance than during an unscheduled maintenance event. The replacement parts may be preordered prior to the scheduled maintenance and installed while other parts are being maintained, thereby minimizing the time that the wind turbine 10 shut down and not producing electricity and revenue for the operator. When a part failure occurs during the time that the wind turbine 10 should be operational, the wind turbine 10 may have to be shut down for the entire time required to order, ship and install the replacement parts, which can be significantly longer than the time require for a scheduled maintenance part replacement. The maintenance schedule may be taken into account to adjust the accumulation of fatigue damage so that components will approach their fatigue damage limits close to a scheduled maintenance event for repaired or replaced when the wind turbine 10 would normally be taken out of service for maintenance. Consequently, a part predicted to fail between two scheduled maintenance events may allow the wind turbine 10 be uprated to accumulate more fatigue damage before replacing the part at the next scheduled maintenance. On the other hand, a part predicted to fail before the next scheduled maintenance may result in derating of the wind turbine 10 to slow the fatigue damage accumulation and prolong the life of the part until replacement during the next scheduled maintenance.

Economic factors such as the time value of money and the anticipated revenue to be realized from the power generation of the wind turbine 10 may also be taken into account. Consideration of these economic factors allows uprating and the corresponding increase in power generation to occur in a manner that maximizes the return on the owner/operators' investment in the wind turbine 10. Further discussion of these factors and calculation of the value function V is provided below.

When the off-line value computation routine 120 as described herein is implemented in the system 100, the output of the online lookup table 118 may include maintenance recommendations for various components of the wind turbine 10. The maintenance recommendations may be output to the wind turbine 10 and input to a maintenance repair and replacement transfer function 122, as these recommendations may impact the accumulated fatigue damage determination for the corresponding components. For example, where the maintenance recommendations indicate that a component of the wind turbine 10 should be replaced on a certain date during scheduled maintenance, maintenance action requests or recommendations for the part may be generated indicating the part requiring replacement and the timing of the replacement to coincide with scheduled maintenance. The requests may provide notice and allow sufficient lead time for ordering a replacement part if necessary and having the part on site at the time of the scheduled maintenance. After replacement, the accumulated fatigue damage for the part may be reset to zero in the accumulate fatigue damage storage 116 so that the replacement component initially has minimal impact on the uprating decision. After a period of time and the accumulation of fatigue damage, the replacement component may then begin to factor into the uprating decision.

The system 100 is illustrated and described herein as having an on-line component in the online lookup table 118 and an off-line component in the value computation routine 120 so that mathematically and computationally intensive process of computing the value function may be performed off-line rather than during each control cycle of the wind turbine 10. However, those skilled in the art will understand that the functions performed at the online lookup table 118 and the routine 120 may be distributed between off-line and on-line processes as desired to implement the uprating strategy of the system 100. For example, the functions may be entirely implemented as on-line processes that are performed during each control cycle. Model Predictive Control (MPC) is a real time implementation of dynamic programming wherein the value function may be may be computed in real time on-line for a relatively short term wind forecast horizon. Less computing resources may be required when using the short term forecast such that computation of the value function on-line does not overburden the control system 52 of the wind turbine 10. These and other hybrid distribution of the processing functions of the online lookup table 118 and the routine 120 will be apparent to those skilled in the art, and are contemplated by the inventor as having use in systems 100 for wind turbines 10 in accordance with the present disclosure.

As discussed above, dynamic programming may be used to calculate the information in the online lookup table 118. Dynamic programming is a powerful technique used to solve optimization problems involving multi-stage decision problems having multiple constraints, nonlinear dynamics and other complex factors, and arrive at globally optimal solutions. Wind turbine rerating over time is an example of a multi-stage decision process in which a balance needs to be maintained between the short term goal of producing maximum power, medium term goal of reducing maintenance costs and the long term goal of meeting the guaranteed life.

Dynamic programming includes the idea of a payoff function. In the current context, the payoff consists of the revenue generated due to power production over the design lifetime of the wind turbine 10 minus any penalties incurred due to not meeting the design life. The payoff function is the result of all the rerating decisions and the wind time histories over the turbine design life. Since the wind is stochastic, so is the payoff function. Hence, a rerating strategy is chosen that will maximize the expectation of future payoffs, over all wind variations, out of all the rerating strategies in certain class. Such maximum expected payoff is termed the value function.

One important consideration is the class of rerating strategies to allow. Instead of allowing all possible rerating strategies, the rerating strategy may be restricted to those that depend only on the remaining design life, current fatigue damage estimate based on past data, current wind speed and current turbulence intensity. The power rerating itself is achieved by changing two setpoints, namely the rated speed Ω^{r} and the rated torque T^{r} setpoint.

The present disclosure poses the wind turbine rerating as a dynamic programming problem, and derives the value function and the optimal strategy. Dynamic programming is solved once the value function is computed over the domain of interest. Finding the value function may be difficult computationally, but a few techniques which can solve the problem are also described. The following describes how the solution works when it is ready. The detailed derivation of value function and the optimal strategy are also addressed. Note that subscript and parentheses may be used interchangeably for functions with single input, e.g. w(t) is same as wₜ.

Loads simulations are run offline for winds with varying mean w, turbulence intensity σ, rated torque T^{r} and rated speed Ω^{r} setpoints. Using loads post processing, the wind and rated setpoint specific fatigue damage rates at various load sensors/points in the turbine are computed. I is the set of all such sensors within a turbine. For example, for i′th sensor, the fatigue damage rate is denoted by:

dⁱ(w,σ,T^{r},Ω^{r}) (1)

It should be noted that knowledge of actual design margins on various components may be required, as the fatigue damage value of one indicates the component failure. In addition, wind and rated setpoint specific power is also computed. This is denoted by:

Pⁱ(w,σ,T^{r},Ω^{r}) (2)

Let T be the target design life and t be the time since the wind turbine 10 was placed in service. Offline optimization using dynamic programming generates a value function V (s, D), which depends on the remaining design life s=T−t, and a vector of current subcomponent fatigue damage estimates for all sensors in the turbine D=[D1, D2, . . . ]. a control strategy is also generated:

[T^{r},Ω^{r}]=f(T−t,D,w,σ)=f(s,D,w,σ) (3)

The control strategy generates torque T^{r} and speed Ω^{r} setpoints as a function of remaining design life, current component fatigue damage estimates, current wind speed and turbulence intensity. Prevailing mean wind speed w(t) and turbulence intensity σ(t) estimates are available on the turbine through many possible sensors. The lookup table of the control strategy f(s, D, w, σ), the fatigue damage rates dⁱ(w, σ, T^{r}, Ω^{r}) and power P (w, σ, T^{r}, Ω^{r}) are stored in the turbine long term memory. During the turbine operation, the rated power setpoint is dynamically changed as per the feedback control strategy:

[T^{r}(t),Ω^{r}(t)]=f(T−t,D(t),w(t),σ(t)) (4)

The feedback control strategy uses the remaining design life, fatigue damage estimates and prevailing wind conditions. In addition, the vector of current fatigue damage estimates is updated based upon the prevailing wind conditions. For example:

$$\frac{d {D}^{i} ( t )}{d t} = {d}^{i} ( \text{?} , σ , {T}^{r} , {Ω}^{r} ) \\ ∀ i ∈ I . \\ \text{?} \text{indicates text missing or illegible when filed} \qquad ( 5 )$$

Wind turbine designs can be both extreme and fatigue damage limited. Fatigue loads accumulate over time, while extreme loads present limits on instantaneous loads, deflections, temperatures and the like. In the above formulation, the fatigue damage margin is exploited within the design. Each operating point is assumed to lie within an extreme loads envelope within which all components of the wind turbine 10 are operating below their extreme load limits. Thus, if a certain rated torque T^{r} and rated speed Ω^{r} combination violates the extreme load limits, it would not be allowed as a feasible strategy for fatigue damage optimization. However, in order to expand the operating ranges of the rated torque T^{r} and rated speed Ω^{r}, it is possible to push certain extreme limits. This can be done using real-time feedback on temperatures, currents, voltages, loads sensors like root bending gauges, validated estimators for tip deflections and the like. Using these for online monitoring can reduce the safety margins applied to extreme loads and allow the wind turbine 10 to operate closer to the extreme load limits. If a danger exists that the limits can be crossed, the real-time control can take defensive action to prevent these excursions by over-ruling the rerating commands.

The value function V (s, D) and the optimal rerating strategy f are in the following analysis. Let [symbol] |₀⁷ denote the set of all possible valid rerating strategies fₜ|ₜ₌₀^{T} which use the feedback of fatigue damage estimate and prevailing wind conditions as per equation (3). The value function V is defined as the maximum expected payoff generated within the target life T, using all possible rerating strategies in class [symbol] :

$$V ( s , D ) = \text{?} \{ \text{?} [ \text{?} P ( \text{?} , \text{?} , \text{?} , \text{?} ) d r + φ ( D ( T ) ) \vert D ( T - s ) = D ] \} \\ \text{?} \text{indicates text missing or illegible when filed} \qquad ( 6 )$$

The expected value is over all future winds, which are parameterized by

$$[ \text{?} ( \text{?} ) , \text{?} ( \text{?} ) \text{?} . \\ \text{?} \text{indicates text missing or illegible when filed}$$

For simplicity, these parameters are assumed to be independent and identically distributed bivariate random variable over time, which satisfies the bivariate probability density function p(w, σ). This assumption, though simplistic, allows the problem to be kept tractable.

It should be noted that the above integral payoff P captures the revenue generated by power production. The terminal payoff Φ can reflect the penalties due to premature turbine failure. For example, a candidate totally risk averse terminal payoff could be:

$$φ ( D ( T ) ) = \{ \begin{matrix}0 & if \text{?} ( T ) <= 1 for all i ∈ I \\ - ∞ & otherwise ,\end{matrix} \\ \text{?} \text{indicates text missing or illegible when filed} \qquad ( 7 )$$

Such payoff would generate a totally risk averse rerating strategy which will ensure the target design life as the cost of not doing so, even with a small probability, would be unbearable.

Using standard techniques in dynamic programming, it can be proved that the value function V satisfies the following recursive identity, also known as Dynamic Programming Principle (DPP), with T≧s≧r≧0.

$$V ( s , D ) = \text{?} \{ \text{?} [ \text{?} P ( \text{?} , \text{?} , \text{?} , \text{?} ) d r + V ( \text{?} + \text{?} ) \vert \text{?} = D ] \} \\ \text{?} \text{indicates text missing or illegible when filed} \qquad ( 8 )$$

The dynamics and the control strategy can be discretized in time, in steps of Δt to simplify the DPP:

$$V ( s , D ) = \text{?} \{ \text{?} [ P ( \text{?} , \text{?} , \text{?} , \text{?} ) Δ t + V ( \text{?} + \text{?} ) \vert \text{?} = D ] \}$$

$$\text{?} \text{indicates text missing or illegible when filed}$$

Using the probability distribution p(w, σ) of wind:

$$= \text{?} \{ \text{?} [ P ( \text{?} , \text{?} , \text{?} , \text{?} ) Δ t + V ( s + \text{?} + d ( \text{?} , \text{?} , \text{?} , \text{?} ) Δ t ) ] \} p ( \text{?} , σ ) \text{?} . \\ \text{?} \text{indicates text missing or illegible when filed} \qquad ( 9 )$$

The optimal feedback based rerating strategy may be given by:

$$[ \text{?} , \text{?} ] = f ( \text{?} , \text{?} , \text{?} , \text{?} ) \text{?} [ P ( \text{?} , \text{?} , \text{?} , \text{?} ) Δ t + V ( s + \text{?} + d ( \text{?} , \text{?} , \text{?} , \text{?} ) Δ t ) ] . \\ \text{?} \text{indicates text missing or illegible when filed} \qquad ( 10 )$$

Optimal rerating strategy is the solution of equation (10) which requires prior computation of value function V (s, D). The value function is the solution of the recursive identity equation (9), satisfying the following boundary conditions at the end of design life:

V(0 D̅)=φ( D̅), (11)

where Φ is the payoff at the terminal time. A candidate totally risk averse terminal payoff is given by equation (7).

There are several methods for computing the value function. Value iteration and policy iteration are few commonly used as discussed in Bertsekas, D, Dynamic Programming and Optimal Control, Athena Scientific, 3^{rd} edition, 2007, which is incorporated by reference herein. Neuro-dynamic programming and approximate dynamic programming are other approaches. Almost all methods see an exponential growth in computation as a function of dimensionality. Hence, it is advisable to keep the problem simple while capturing the important underlying tradeoff. For example, if turbines are known to most likely fail due to specific fatigue damage limited components, it is advisable to include only these components in the fatigue damage evolution equations (5). As an example of computational burden, attention is drawn to N_{I} bottleneck fatigue limited loads in the turbine, discretize each fatigue damage in N_{D} steps between 0 and 1, discretize the target life in N_{T} steps, then, moving backwards in time, the iteration equation (9) will need to be carried out N_{T}N_{D}^{NI} times. If we decide to use N_{P} possible downrating setpoints, N_{W} wind bins and N_{σ} turbulence intensity bins, each iteration will involve N_{W}N_{σ}N_{P} subcomputations.

The strategy may be extended to include maintenance costs, retrofits or part replacements, wind forecasts, seasonal wind variations, and feedback from a condition monitoring system as discussed above, at the expense of increase in computation. All the computation can be done offline, and online computations can be minimal. When expanded in this manner, the above strategy can allow for different types of intelligent behaviors. The wind turbine 10 can build up the fatigue appetite for forecasted high winds by downrating in low winds. This may apply to known seasonal or daily wind variations as well.

The wind turbine 10 can downrate if CMS data indicates that a bearing is deteriorating, so that the failure is avoided until the next scheduled maintenance. This requires the validated load simulation transfer function 108 from the CMS data to the fatigue damage or time to failure, and its dependence on power. This framework can be also used to plan scheduled maintenances and part replacement. Thus, in addition to the rerating, maintenance and part replacement decisions are also made by the same optimization framework.

If the wind forecasts are available, then the probability distribution of the wind states p(w, σ) would not be constant over time. If the annual wind variations are known, the distribution will vary with the period of one year. If the forecast during next few days is available with high accuracy, the distribution will have sharper peaks over that time span. Thus we can replace p(w, σ) can be replaced by pₜ(w, σ) to capture knowledge of such time varying probability distribution. Such can be directly used in the DPP equation (9) to yield the value function. Typically, annual wind variation is well-known, and can be used in computing nominal value function. When new information about the short term wind forecasts become available, the same can be used to recompute the value function only for the time span of available predictions. The long term nominal value function can serve as the terminal condition for this subproblem and only the value function re-computation needs to be done for a shorter time span.

Where a choice of which parts to replace at the time of normal scheduled maintenance intervals is available, and specified cost of scheduled and unscheduled maintenance (including logistics, downtime and maintenance/replacement cost) are known, then maintenance and replacement decisions can be readily added to the above optimization framework. In order to add such, a hierarchical reliability model of the turbine and effect of the maintenance/part replacement on the component fatigue damage is needed. Specifically, at time t, the choice of choosing any maintenance action mₜε [symbol] ₜ may be available. This may include replacement/repair of any number of parts. Each maintenance action m has a well-understood effect on the component fatigue damage, given by fₘ(D). It should be noted that D is the vector of initial fatigue damages, and fₘ(D) denotes the fatigue damage vector after the maintenance action m. For example, replacing pitch bearings will reset their fatigue damage to zero. Note that there is always a do-nothing maintenance action m̅ available. Under such action, f _{m̅}(D)=D. There is an associated cost with each maintenance action C(t, mₜ).

Fatigue damage of 1 on any component indicates part failure, and turbine shutdown. Leaving the wind turbine 10 in such state may incur loss of revenue. This condition is captured by making the domain of downrating controls dependent on the fatigue damage vector, so that when fatigue damage exceeds one, the wind turbine 10 produces zero power:

$$( \text{?} , \text{?} ) ∈ ℱ ( D ) = \{ \begin{matrix}all possible reratings & if max ( {f}_{m} ( D ) ) < 1 \\ ( 0 , 0 ) & otherwise .\end{matrix} \\ \text{?} \text{indicates text missing or illegible when filed} \qquad ( 12 )$$

Such formulation can encompass a wide array of real world constraints. For example, for off-shore wind turbines 10, the cost of maintenance will be low only for preplanned scheduled maintenance intervals. It may be expensive or impossible to carry out unscheduled maintenance. In the latter case, [symbol] ₜ may be empty for times outside the scheduled maintenance times. In such cases, if the downrating can postpone the component failure till the next scheduled maintenance, it can be very economical.

Factoring the time value of money is used widely in stock portfolio optimization. Due to the interest rate on capital, power generated now may be more valuable than the same amount of power generated in the future. This can be easily incorporated in the DPP formulation by adding a discounting rate k for the future revenues, and replacing P (wₜ, σₜ, T^{r}ₜ, Ω^{r}ₜ) by P (wₜ, σₜ, T^{r}ₜ, Ω^{r}ₜ)ₑ^{-kt} in equation (6). It may also be possible to add extension on this idea based on energy futures both in the near term and the long term.

The value iteration for a simplified problem was shown in equation (9). An equivalent value iteration equation for the expanded problem would be as follows:

$$V ( s , D ) = \text{?} \{ \text{?} [ P ( \text{?} , \text{?} , \text{?} , \text{?} ) ) b Δ t - C ( T - s , m ) + V ( s + \text{?} ( \text{?} ) + d ( \text{?} , \text{?} , \text{?} , \text{?} ) \text{?} ] \} \text{?} ( \text{?} , \text{?} ) \text{?} . \\ \text{?} \text{indicates text missing or illegible when filed} \qquad ( 13 )$$

where [symbol] is as defined in equation (12), b is the energy price per unit of electricity, pₛ(w, σ) is the time varying probability distribution of the wind forecast, k is the discount rate on the future revenues, C(T−s, m) indicates the cost of carrying out the maintenance action m at the time T−s, fₘ( D̅) indicates fatigue damage after the maintenance action m when starting from damage D̅, d(w, σ, T^{r}, Ω^{r}) and P(w, σ, T^{r}, Ω^{r}) are as defined in equations (5) and (2), respectively. The discretization is approximate. Interval Δt should ideally be greater than the time needed to carry out unscheduled maintenance, but lesser than the time in between successive scheduled maintenances and timescale of seasonal wind variation.

While only certain embodiments have been set forth, alternatives and modifications will be apparent from the above description to those skilled in the art. These and other alternatives are considered equivalents and within the spirit and scope of this disclosure and the appended claims.

What is claimed is:

1. A method for rerating a wind turbine, comprising:
determining a wind speed, a wind turbulence, an actual accumulated fatigue damage amount for at least one component of the wind turbine, and a remaining design life amount for the wind turbine; and
calculating, by a computer processer, an updated rated speed and an updated rated torque based on the wind speed, the wind turbulence, the actual accumulated fatigue damage amount and the remaining design life amount.

2. The method of claim 1, comprising:
inputting the wind speed, the wind turbulence, the actual accumulated fatigue damage amount and the remaining design life amount into a value function is; and
calculating the updated rated speed and the updated rated torque from using the value function based on the wind speed, the wind turbulence, the actual accumulated fatigue damage amount and the remaining design life amount.

3. The method of claim 2, wherein the value function is one of a lookup table and a mathematical formula.

4. The method of claim 2, comprising:
calculating the value function based on a weather forecast; and
recalculating the value function in response to a change in the weather forecast.

5. The method of claim 1, comprising determining a design accumulated fatigue damage amount for the at least one component based on a time since the wind turbine was placed into service, wherein the updated rated speed and the updated rated torque can be greater than a design rated speed and a design rated torque where the actual accumulated fatigue damage amount is less than the design accumulated fatigue damage amount.

6. The method of claim 5, wherein the updated rated speed and the updated rated torque can be less than the design rated speed and the design rated torque where the actual accumulated fatigue damage amount is greater than a design accumulated damage amount.

7. The method of claim 1, comprising:
measuring a value of at least one parameter at the wind turbine; and
calculating the actual accumulated fatigue damage amount based on the value of the at least one parameter.

8. A method for determining an updated rated power for a wind turbine, the method comprising:
measuring at least one operating parameter for at least one component of the wind turbine as the wind turbine operates at a design rated speed and a design rated torque;
calculating, by a computer processor, an actual accumulated fatigue damage amount for the at least one component based on a measured value of the at least one operating parameter;
calculating an updated rated speed and an updated rated torque for the wind turbine based on the actual accumulated fatigue damage amount, a wind speed, a wind turbulence and a remaining design life amount of the wind turbine; and
causing the wind turbine to operate at the updated rated speed and the updated rated torque.

9. The method of claim 8, wherein calculating the actual accumulated fatigue damage amount comprises:
determining a damage accumulation rate for the at least one component based on the measured value of the at least one operating parameter; and
multiplying the damage accumulation rate by a damage accumulation time period to produce a time period accumulated fatigue damage amount.

10. The method of claim 9, comprising:
storing a total accumulated fatigue damage amount for the at least one component;
adding the time period accumulated fatigue damage amount to the total accumulated fatigue damage amount to produce an updated total accumulated fatigue damage amount;
determining the updated rated speed and the updated rated torque based on the updated total accumulated fatigue damage amount.

11. The method of claim 10, comprising setting the total accumulated fatigue damage amount to zero after the at least one component is replaced.

12. The method of claim 8, wherein determining the updated rated speed and the updated rated torque comprises inputting the wind speed, the wind turbulence, the actual accumulated fatigue damage amount and the remaining design life amount into a value function.

13. The method of claim 12, wherein the value function is one of a lookup table and a mathematical formula.

14. The method of claim 12, comprising:
calculating the value function based on a weather forecast; and
recalculating the value function in response to a change in the weather forecast.

15. The method of claim 8, comprising determining a design accumulated fatigue damage amount for the at least one component based on a time since the wind turbine was placed into service, wherein the updated rated speed and the updated rated torque can be greater than the design rated speed and the design rated torque where the actual accumulated fatigue damage amount is less than the design accumulated fatigue damage amount.

16. The method of claim 15, wherein the updated rated speed and the updated rated torque can be less than the design rated speed and the design rated torque where the actual accumulated fatigue damage amount is greater than the design accumulated fatigue damage amount.

17. The method of claim 8, wherein calculating the actual accumulated fatigue damage amount comprises:
determining a condition monitoring system transfer function based on historical condition monitoring system data and failure data from a previous wind turbine;
inputting the measured value of the at least one operating parameter into the condition monitoring system transfer function;
outputting a fatigue damage accumulation rate from the condition monitoring system transfer function.

18. The method of claim 8, wherein calculating the actual accumulated fatigue damage amount comprises:
determining a load simulation transfer function based on simulations of loads created on components of the wind turbine by combinations of the wind speed and the wind turbulence;
inputting the measured value of the at least one operating parameter into the load simulation transfer function;
outputting a fatigue damage accumulation rate from the load simulation transfer function.

19. The method of claim 8, wherein the at least one operating parameter is an actual load applied to the at least one component of the wind turbine, and wherein calculating the actual accumulated fatigue damage amount comprises:
determining a load estimate transfer function based on damage accumulation caused by load amounts;
inputting a measured actual load applied to the at least one component into the load estimate transfer function;
outputting a fatigue damage accumulation rate from the load estimate transfer function.

20. The method of claim 8, wherein determining the updated rated speed and the updated rated torque comprise:
inputting a maintenance schedule for the wind turbine and a cost of replacement for the at least one component during scheduled and unscheduled maintenance; and
determining the updated rated speed and the updated rated torque based on the maintenance schedule and the cost of replacement.
